(19) United States
(12) Patent Application Publication
(10) Pub. No.: US 2005/0088910 A1
(43) Pub. Date: Apr. 28, 2005

(54) Housing and support structure for mixers for fluid products

(75) Inventors: Guido Greco, Panaro (MO) (IT); Gianfranco Beltrami, Stradella (PV) (IT)

Correspondence Address: SUGHRUE MION, PLLC, 2100 PENNSYLVANIA AVENUE, N.W., SUITE 800, WASHINGTON, DC, 20037, US

(73) Assignee: CPS COLOR EQUIPMENT SpA

(21) Appl. No.: 10/973,288

(22) Filed: Oct. 27, 2004

(30) Foreign Application Priority Data
Oct. 28, 2003 (EP) 03425695.8

(51) Int. Cl. B01F 15/00

(52) U.S. Cl. 366/209

(57) ABSTRACT

A housing and support structure for mixers for fluid products comprises a main body (21, 48) having an opposed first and second portion (34, 50), joined to each other so as to define a housing space (22, 52) for a container of fluid products. The first portion (34, 50) has a mass different from the mass of the second portion (34, 50) such as to balance, in use, a non-balanced container of fluid products.

The present invention relates to a housing and support structure for mixers for fluid products, and in particular to a holder for supporting, in use, a non-balanced container of products to be mixed, comprising a main body with an opposed first portion and second portion, joined to each other about a housing space for housing a container.

In the field of mixing of fluid products, it is known to use non-balanced containers of fluid products, that is to say, with a greater mass in proximity to a peripheral region thereof. The best known examples of non-balanced containers are those in which a part of the overall volume of the container is occupied by a built-in handle rather than by the fluid product itself. Such a solution is customarily adopted in order to improve storage of the containers.

It is known to produce holders for housing non-balanced containers in which the container is placed in a non-centred position with respect to the holder itself, that is to say, with the heaviest portion closer to the centre of the holder.

The main problem of the housing and support holders or structures of known type is that the compensation for the non-balanced mass of the container is effective only in the case of small imbalances. The geometric displacement of the container with respect to the centre of the holder, in fact, cannot be very great because of problems of bulk and of forces of inertia. The placing of non-balanced containers in a non-centred position, furthermore, is strictly bound to the geometry of the container and is unsuitable for containers of very irregular or positively asymmetric shape.

A further drawback of the holders of known type lies in the fact that they cannot ever be used with a balanced container.

In such a situation, in fact, the geometry of the balanced container creates an unwanted imbalance, rendering such a holder unsuitable for supporting the container in a mixing device.

A further drawback of the holders of known type, apart from those mentioned above, lies in the asymmetric shape of the holder which entails a major difficulty in production and therefore a higher cost.

U.S. Pat. No. 6,106,143 discloses a vibrating device having a vibrating table supported eccentrically on a flywheel, wherein ad adjustable counterbalance weight is connected to the flywheel for balancing the centrifugal forces occurring.

U.S. Pat. No. 3,985,307 discloses a dental amalgam producing machine adapted to receive an amalgam mulling container at one end and having a counter weight at the other end, the arm being inclined with respect to the horizontal.

It is an aim of the present invention to solve the problems of the prior art and provide a housing and support structure for mixers for fluid products which is suitable for supporting, in use, a container of products to be mixed and which is capable of compensating even for very great imbalances of non-balanced containers.

Another aim of the present invention is to create a housing and support structure which can be selectively balanced for mixing, in use, both non-balanced containers of fluid products and balanced containers.

A further aim of the present invention is that of providing a housing and support structure which is economic, highly reliable, durable and such as to reduce the vibrations and wear on the mixer on which it is used.

In order to achieve the aims indicated above, the subject of the present invention is a housing and support structure, or holder, of the type indicated in the preamble of the present description in which the first portion has a mass different from the mass of the second portion, so as to balance, in use, a non-balanced container of fluid products.

According to one of the embodiments of the present invention, it is possible to produce a main body which comprises a box-like member with two portions that are symmetrical to each other and one of which is heavier than the other because, for example, but not by way of limitation, it is ballasted with balancing masses. In this way, an unbalanced container may be placed in a centered position with respect to the holder, since the imbalance deriving from it is balanced by a portion of the holder of greater weight than the other portions around the housing space. When a container is inserted into the holder, the effect which is produced by the greater weight of one portion with respect to the others is that of displacing the centre of gravity of the holder on its central axis. The direct consequence is a lesser development of forces of inertia which act on the movement system for moving the holder, and therefore less vibration and wear.

According to a preferred embodiment, the first portion comprises balancing masses disposed in proximity to a lateral region of the housing space. The advantage of this embodiment is that of being able to construct a holder of regular geometric shape on which balancing masses are distributed in a predetermined position depending on the type of container to be mixed. A preferred example provides for the housing space to extend according to a main axis of symmetry and for the balancing masses to be distributed asymmetrically with respect to the main axis of symmetry.

The balancing masses may, for example, but not exclusively, be coupled to an outer surface portion of the main body, without the need therefore to render the internal geometry of the housing space more complex.

The balancing masses coupled to the holder may be fixed to the main body or be selectively engageable therewith, on the basis of the choice of advantages provided by these two solutions. In particular, the production of masses fixed to the main body is particularly economical and advantageous when the holder is always used with a single type of container. When, on the other hand, the holder is used with different types of non-balanced containers, it is of advantage to produce balancing masses selectively engageable with the main body, in order to add or remove them to an extent depending on the amount of imbalance to be compensated. In such a case, if balancing masses which are of different weights from one another are produced according to a graduated scale of weights, very precise balancing is possible.

According to a further, particularly advantageous embodiment of the present invention, the main body of the holder comprises adaptor means inserted inside it. The adaptor means comprise, for example, a further holder that can be selectively inserted into the first holder, with the aim of reducing the housing space to a size suitable for containers of small format. The adaptor means therefore define the housing space into which the container to be mixed is inserted.

Optionally, the adaptor means comprise a portion having a weight such as to balance the effect on the centre of gravity of the holder, so as to permit the mixing also of balanced containers. The adaptor means may also comprise balancing masses, for example, but not by way of limitation, fixed thereto or selectively engageable therewith.

According to a further alternative embodiment of the present invention, it is possible to produce a holder in which all the balancing masses are disposed on the adaptor means. In this case, preferably, balanced adaptor means are provided for each type of container that it is wished to mix, being interchangeable with one another within the holder, or balancing masses separably coupled to the adaptor means are used to balance them each time on the basis of need.

The holder advantageously comprises means for the orientation of the adaptor means which define a sole correct position for insertion of the adaptor means into the main body. Such orientation means comprise, for example, a tongue and a slot which in the correct insertion position are aligned and inserted one into the other, or a handle coupled to the adaptor means. The correct insertion position is, for example, but not exclusively, that in which the first and the third portion in turn neutralize their effect, in the case where a balanced container is to be mixed, or that in which the first portion neutralizes the effect of the non-balanced mass of the container, and, in each case, is a predetermined position.

In a particularly advantageous embodiment, a kit is provided, comprising a plurality of holders according to one of the preceding embodiments or variants, of decreasing dimensions and insertable one into another. With this solution it is possible to adapt the holder to containers of any size. If in addition, or as an alternative, each holder has the at least a first portion of the main body of a different weight from the at least a first portion of the other holders, it is possible to have a main holder into which can be inserted a holder selected from the plurality of holders on the basis of the imbalance of the container to be mixed.

Further characteristics and advantages will become clear from the following description with reference to the appended drawings, provided purely by way of non-limiting example, in which:

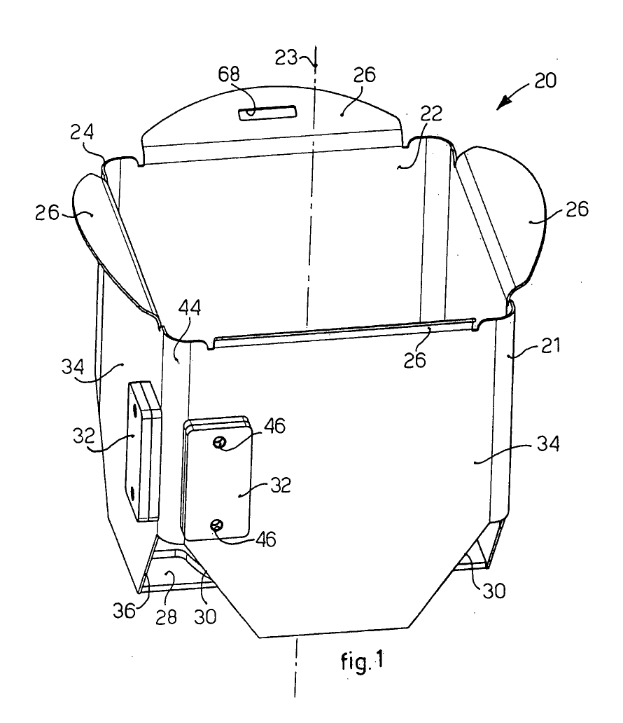

FIG. 1 is a perspective view of a holder according to the present invention, comprising, on an outer side, balancing masses to compensate the shifting of the centre of gravity of a container with respect to the axis of symmetry of the holder;

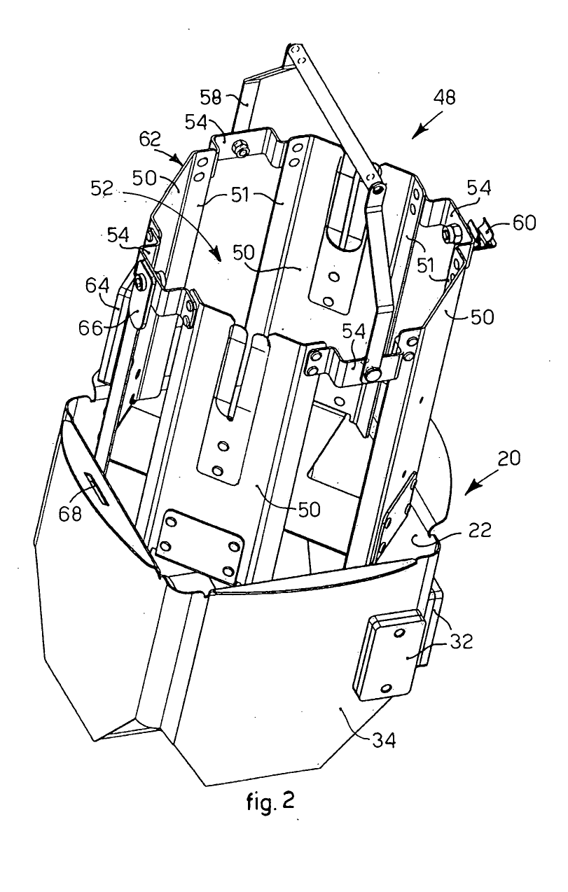

FIG. 2 is an exploded perspective view of a holder of the present invention comprising the holder of FIG. 1 and an adaptor inserted inside it and equipped with balancing masses on one side in a position such as to cancel out the effect of the masses applied to the holder of FIG. 1;

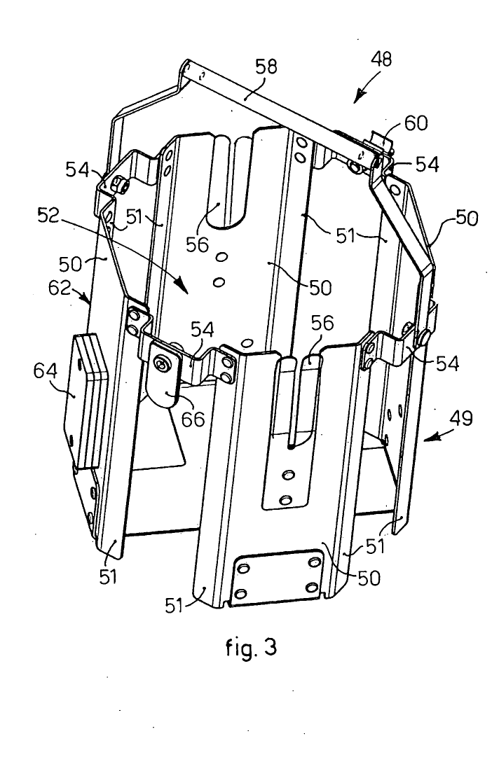

FIG. 3 is a perspective view of the adaptor of FIG. 2;

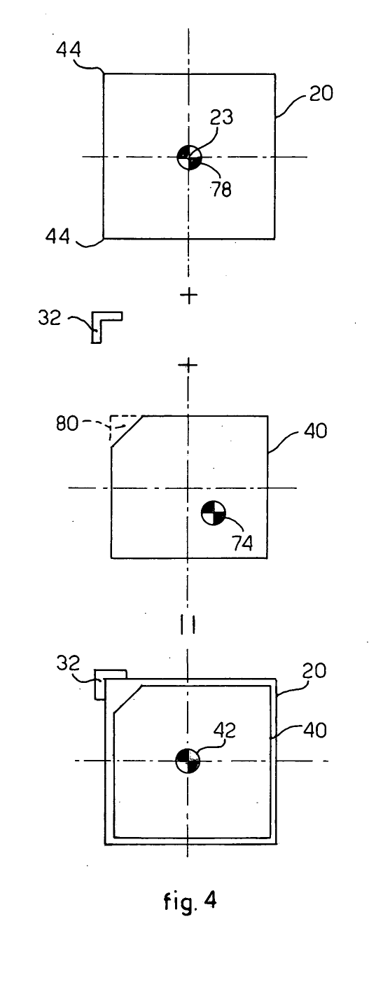

FIG. 4 is a diagram which illustrates a method for balancing a non-balanced container of fluid products, which provides for the use of the holder of FIG. 1; and

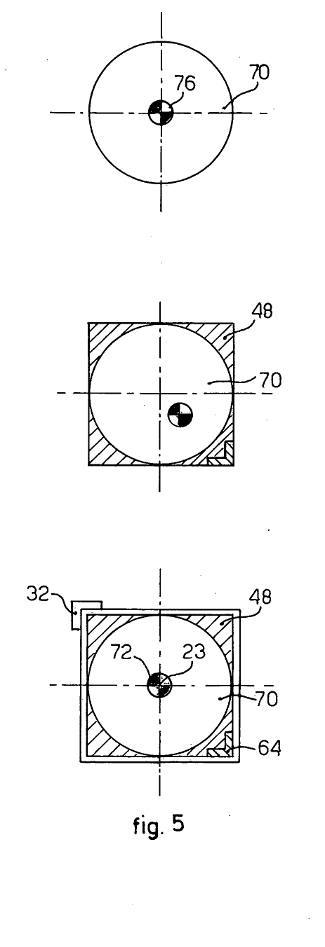

FIG. 5 is a diagram which illustrates a method for balancing a balanced container of fluid products, which provides for the use of the holder and the adaptor of FIG. 2.

With reference to FIG. 1, a holder 20 comprises a box-like member 21 with an inner space 22 for housing a container of fluid products. The box-like member 21 preferably, but not by way of limitation, has a cross-section that is square, circular, or in any case symmetrical with respect to a central axis 23 of the holder 20. The central axis 23 corresponds, in use, to an axis of motion with respect to which the holder 20 undergoes rotation or translation, and/or an axis of symmetry, or a main axis of a device for connecting the holder to a mixer.

The inner space 22 is open at the upper end to allow the insertion of a container. The box-like member 21 comprises an upper edge 24 on which lead-in tabs 26 may be provided for guiding the container at the start of insertion. The tabs 26 are inclined towards the outside so as to widen out the cross-section of the inner space 22 gradually from the inside towards the outside. At the base 28 of the inner space 22, apertures 30 are provided, disposed at the corners of the cross-section of the inner space 22 such that, when the container is inserted into the inner space 22, there is no interference between the lower corners of the container and those of the inner space 22. The box-like member 21 comprises a plurality of lateral walls 34, preferably inclined to one another, for example orthogonally, and a base wall 36. Preferably, but not by way of limitation, the box-like member 21 has one or more balancing masses 32 placed on the lateral walls 34. With reference now to FIG. 4, the overall mass of the balancing masses 32 is such that the centre of gravity (not illustrated) of the sole holder 20 comprising the balancing masses 32 falls outside the central axis 23, while the resulting centre of gravity 42, of the whole comprising a non-balanced container 40 inserted into the holder 20 equipped with balancing masses 32, falls on the central axis 23 of the holder 20.

Once again with reference to FIG. 1, the balancing masses 32 may be positioned, for example, but not necessarily, in proximity to a corner edge 44 joining two lateral walls 34, preferably in a symmetrical position with respect to the corner edge 44. In addition, or as an alternative, the balancing masses 32 may be positioned on a base wall 36 of the box-like member 21, still in proximity to a joining corner edge 44. In an embodiment that is not illustrated, the balancing masses are positioned inside the holder, for example in its inner space.

Preferably, but not by way of limitation, the balancing masses 32 are fixed to the holder 20 by means of screws inserted in holes 46 provided in the balancing masses 32. An expert in the field may of course single out further equivalent fixing means of known type, such as, for example, bolts, rivets, welding or adhesive securing, without thereby departing from the scope of the present invention. The balancing masses 32, as an alternative, may be produced in one piece with the box-like member 21, for example by producing portions of the box-like member 21 from materials of different specific weight or with similar materials but having different thicknesses. According to an embodiment that is not illustrated, the balancing masses are coupled separably to the box-like member so that they can be completely removed or increased on the basis of the amount of shift of the centre of gravity of the non-balanced container with respect to the central axis of the holder. Examples of this type of coupling provide for the coupling of the balancing masses to the holder, for example in predetermined positions, by means of screws, by magnetic coupling or by means of housing in suitably arranged spaces.

With reference to FIG. 2, an alternative form of the holder 20 provides an adaptor 48 inserted into the inner space 22 of the holder 20. The adaptor 48 comprises a body 49 formed by vertical wall members 50 disposed symmetrically and connected along vertical edges 51 preferably by means of stirrups 54 to define a second inner space 52 of dimensions preferably smaller than the inner space 22 and also open at the upper end. Alternatively, the second inner space 52 may be bounded by a single piece or wall member forming the body 49, such as, for example, a drawn piece, or bounded by a metal cage formed of metal profile sections, or of other material, or also by a mesh.

One or more of the vertical wall members 50 are coupled to centering members 56, for example resilient thin plates projecting towards the inside of the second inner space 52 to centre and retain the containers which are inserted during use. Preferably, the centering members 56 are provided in symmetrical pairs, that is to say, mounted or produced so as to face each other symmetrically in the second inner space 52, however this may be produced.

The adaptor 48 may also comprise a handle 58 mounted at its upper end, for example coupled by means of screws to two symmetrical stirrups 54. The handle 58 is preferably connected so that it can pivot with respect to the body 49 of the adapter 48 from a working position, in which it is raised above the aperture of the second inner space 52, to a rest position, in which it is reclined laterally to the vertical wall members 50 and in which it is preferably, although not by way of limitation, retained by a support 60, for example of the jaw type.

The adaptor 48 has a vertical outer surface 62, for example the back of a wall member 50, to which second balancing masses 64 are coupled. Said second balancing masses are fixed or selectively engaged, or produced in one piece on said vertical outer surface 62, in the same manner as described for the balancing masses 32 on the lateral walls 34 of the box-like member 21. The second balancing masses 64 may of course also be disposed on a base wall of the adaptor 48 or inside it, as in the second inner space 52.

The adaptor 48 comprises orientation means which allow it to be inserted into the inner space 22 in a sole predetermined position and to remain in that position during use. Said orientation means comprise, for example, the handle 58 when it is in the rest position, and/or a centering member 66, comprising a vertical tongue or pin which, in a working position in which the adaptor is completely and correctly inserted into the inner space 22, is inserted into a slot, or hole 68 (see FIG. 1) provided on one of the lead-in tabs 26 of the holder 20.

The predetermined position is the only position permitted by the coupling between the centering member 66 and the slot 68, and in that position the adaptor inserted into the inner space 22 has the second balancing masses 64 in a position such as to neutralize the effect of the balancing masses 32. Preferably, said second balancing masses 64 are located facing the corner edge 44 opposed to that in proximity to which the balancing masses 32 are positioned on the box-like member 21.

With reference to FIG. 5, the second balancing masses 64 are such that the whole comprising a balanced container 70 inserted into the adaptor 48, inserted in its turn into the inner space 22 of the holder 20, and further comprising the balancing masses 32 and the second balancing masses 64, has its centre of gravity 72 disposed on the central axis 23 of the holder 20.

With reference to FIG. 4, a method for balancing a holder 20 of a mixer for fluid products, provided with a central axis 23 on which the centre of gravity 78 of the holder 20 falls, provides for supplying the holder 20 with one or more balancing masses 32 in a lateral position obtaining a rebalanced holder 20, that is to say, with the centre of gravity 78 no longer on the central axis 23. A non-balanced container of fluid products to be mixed 40, for example of the type with a portion 80 missing or occupied by a handle, is inserted into the re-balanced holder 20 or into the holder 20 to which the balancing masses 32 are then added in an amount sufficient to compensate for the imbalance of the non-balanced container 40. The non-balanced container 40, when it is inserted into the holder, has a centre of gravity 74 which does not fall on the central axis 23 of the holder 20, for which reason it is inserted into the holder 20 with an orientation such that the balancing masses 32 compensate for the shifting of the centre of gravity 74 of the container 40, causing the resulting centre of gravity 42 of the whole comprising the non-balanced container 40 and the holder 20, equipped with balancing masses 32, to fall on the central axis 23 of the holder 20.

FIG. 5 illustrates the case where the mixer must be used with the re-balanced holder 20, that is to say, equipped with balancing masses 32, for mixing a balanced container 70 of dimensions smaller than those of the non-balanced container 40. To neutralize the effect of the balancing masses 32, the balanced container is inserted into an adaptor 48 equipped with second balancing masses 64 which exert an action opposed to that of the balancing masses 32, and which cause the centre of gravity 76 of the balanced container 70 to fall on the axis of symmetry or rotation 23 of the holder 20. To this end, in the predetermined position the second balancing masses 64 are located preferably in a region opposed to a region in which the balancing masses 32 are located.

In the case where the dimensions of the containers to be mixed are smaller, it is possible to adopt a second adaptor (not illustrated) inserted into the adaptor 48, or more than one second adaptor inserted one into the other and then into the adaptor 48. Said adaptors of decreasing dimensions may be supplied as a series of adaptors paired with the holder 20. Each adaptor of the series may have the second balancing masses 64 fixed or selectively engageable.

Considering the embodiment described with reference to FIG. 2, an expert in the field will have no difficulty in understanding that it is possible to provide an adaptor 48 for each type of container that it is intended to mix. Said adaptors may be supplied for example as a series of adaptors paired with the holder 20, each with different balancing and if necessary with second balancing masses separably coupled to correct small balancing errors.

In the case where no balancing mass 32 is coupled to the holder 20, in so far as only the second balancing masses 64 are present on the adaptor 48, it is possible to provide a series of adaptors 48, each of which comprises second balancing masses 64 sufficient to balance a non-balanced type of container. Alternatively, in association with the holder 20 without balancing masses 32, second balancing masses 64 selectively engaged with the holder 48 may be provided. In such a case, for each type of container the adaptor 48 comprises specific second balancing masses 64 for balancing it.

In an embodiment that is not illustrated, the adaptor does not have second balancing masses and performs only a function of adaptor of shape. Said adaptor may be associated both with a holder equipped with balancing masses, and with any other adaptor.

For completeness, it is intended that each of the examples described may also have one or more of the characteristics of the others; thus, for example, the holder 20 without balancing masses 32, or with selectively engaged balancing masses 32, may be provided in all cases where its application is possible, such as, for example, in association with the series of adaptors inserted one into another.

The holder 20 preferably has a central axis 23 coinciding with an axis of rotation when it is used in an orbital, gyroscopic, or roto-vibrational mixer or one with another type of motion composed of at least a rotation; however, for the aim of the present matter, there is no difference in considering such an axis to be also or only an axis of symmetry, for example when the mixer in which the holder is employed does not have a rotatory motion.

One of the advantages of the present invention lies in the handle 58, which facilitates the operations of loading and unloading into and out of the holder 20 the containers to be mixed.

Another advantage of the present invention lies in the balancing masses 32, which make it possible to compensate for imbalances of containers due to very irregular and asymmetrical geometries.

Finally, the apertures 30 at the base 28 of the inner space 22 advantageously allow a container with a vertical axis of symmetry to be housed in the inner space with its own vertical axis of symmetry coinciding with the central axis 23 of the holder, since interference between the corners of the inner space 22 and of the container which could constrain the container to stand in an incorrect position is avoided.

1. A housing and support structure for mixers for fluid products, comprising a main body (21, 48) having an opposed first and second portion (34, 50), joined to each other so as to define a housing space (22, 52) for a container of fluid products, characterized in that the first portion (34, 50) has a mass different from the mass of the second portion (34, 50) such as to balance, in use, a non-balanced container of fluid products.

2. A housing and support structure according to claim 1, characterized in that the first portion (34, 50) comprises balancing masses (32, 64) disposed in proximity to a lateral region (44, 62) of the housing space (22, 52).

3. A housing and support structure according to claim 2, characterized in that the housing space extends along a principal axis of symmetry (23), the balancing masses (32, 64) being distributed asymmetrically with respect to said main axis of symmetry (23).

4. A housing and support structure according to claim 3, characterized in that the balancing masses (32, 64) are coupled to an outer surface portion (34, 62) of the main body (21, 48).

5. A housing and support structure according to claim 2, characterized in that the balancing masses (32, 64) are inseparable, in use, from the main body (21, 48).

6. A housing and support structure according to claim 2, characterized in that, in use, the balancing masses (32, 64) are selectively engaged with the main body (21, 48).

7. A housing and support structure according to claim 1, characterized in that the main body (21, 48) comprises adaptor means (48) inserted into the housing space (22).

8. A housing and support structure according to claim 7, characterized in that the adaptor means (48) comprise a housing space (52) for a container of fluid products.

9. A housing and support structure according to claim 8, characterized in that the adaptor means (48) comprise the first portion (50) of the main body and the second portion (50) of the main body.

10. A housing and support structure according to claim 8, characterized in that the adaptor means comprise at least one third portion of the main body having a mass approximately equal to the first portion and opposed to the first portion.

11. A housing and support structure according to claim 10, characterized in that the at least one third portion comprises second balancing masses (64) coupled to an outer surface portion (62) of the adaptor means.

12. A housing and support structure according to claim 11, characterized in that the second balancing masses (64) are fixed to the adaptor means (48).

13. A housing and support structure according to claim 11, characterized in that the second balancing masses (64) are selectively engaged with the adaptor means (48).

14. A housing and support structure according to claim 7, characterized in that it comprises means (58, 66) for the orientation of the adaptor means (48) which define a sole correct position for insertion of the adaptor means (48) into the main body (21).

15. A housing and support structure according to claim 14, characterized in that the orientation means comprise a tongue (66) and a slot (68) which in the correct insertion position are aligned and inserted one into the other.

16. A housing and support structure according to claim 14, characterized in that the orientation means comprise a handle (58) coupled to the second holder (48).

17. A kit comprising a plurality of housing and support structures according to claim 1, having decreasing dimensions and insertable, in use, one into another.

18. A kit comprising a plurality of housing and support structures according to claim 1, characterized in that each housing and support structure has the first portion of the main body (21, 48) of a weight different from the first portion of the other housing and support structures.
